(19) United States
(12) Patent Application Publication
(10) Pub. No.: US 2015/0296168 A1
(43) Pub. Date: Oct. 15, 2015

(54) Display Screen Dust Cover Device

(71) Applicant: James Ozley, Phoenix City, AL (US)

(72) Inventor: James Ozley, Phoenix City, AL (US)

(21) Appl. No.: 14/252,275

(22) Filed: Apr. 14, 2014

(51) Int. Cl. H04N 5/64; G02B 27/00; H04N 5/65

(52) U.S. Cl. CPC H04N 5/64; H04N 5/65; G02B 27/0006

(57) ABSTRACT

A display screen dust cover device prevents dust buildup on a display screen for a desktop computer, television monitor, or the like. The device includes a cover having a front panel, a back panel, and a perimeter wall coupled to and extending between the front panel and the back panel. The perimeter wall has a top section extending along respective top edges of the front panel and the back panel. The perimeter wall has a pair of lateral sections coupled to and extending between respective associated side edges of the front panel and the back panel. Thus, the perimeter wall defines an interior space between the front panel and the back panel. A handle is coupled to the cover. The handle extends outwardly from the cover facilitating lifting of the cover.

### BACKGROUND OF THE DISCLOSURE

### Field of the Disclosure

The disclosure relates to cover devices and more particularly pertains to a new cover device for preventing dust buildup on a display screen for a desktop computer or the like.

### SUMMARY OF THE DISCLOSURE

An embodiment of the disclosure meets the needs presented above by generally comprising a cover having a front panel, a back panel, and a perimeter wall coupled to and extending between the front panel and the back panel. The perimeter wall has a top section extending along respective top edges of the front panel and the back panel. The perimeter wall has a pair of lateral sections coupled to and extending between respective associated side edges of the front panel and the back panel. Thus, the perimeter wall defines an interior space between the front panel and the back panel. A handle is coupled to the cover. The handle extends outwardly from the cover facilitating lifting of the cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a display screen dust cover device according to an embodiment of the disclosure.

FIG. 2 is a front view of an embodiment of the disclosure.

FIG. 3 is a top view of an embodiment of the disclosure.

FIG. 4 is a bottom back side perspective view of the disclosure.

FIG. 5 is a top front side perspective view of an embodiment of the disclosure in use.

### DESCRIPTION OF THE PREFERRED EMBODIMENT

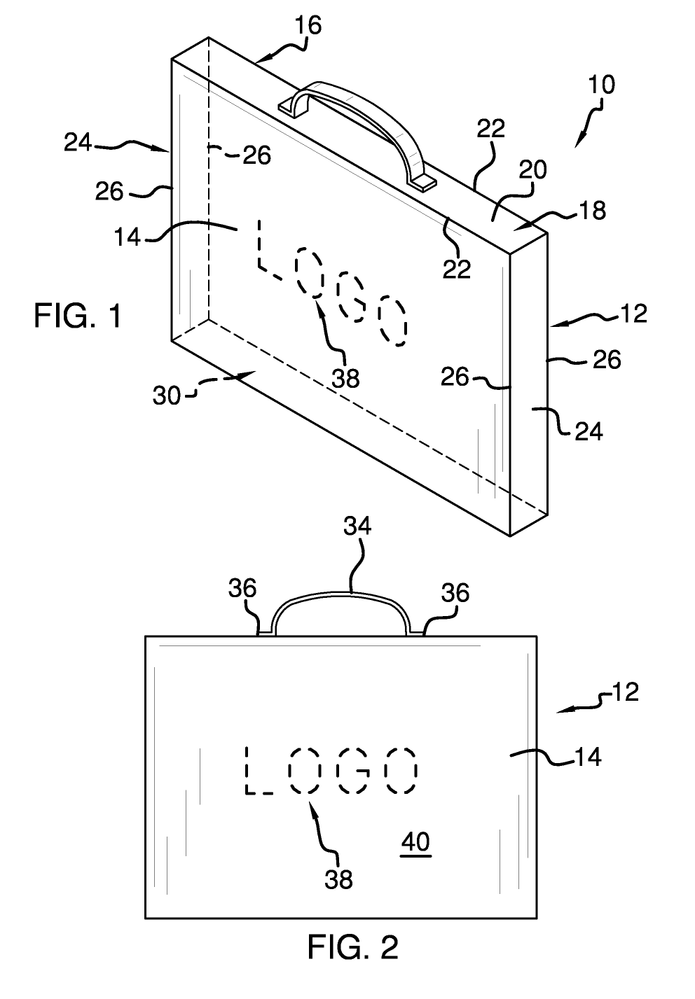

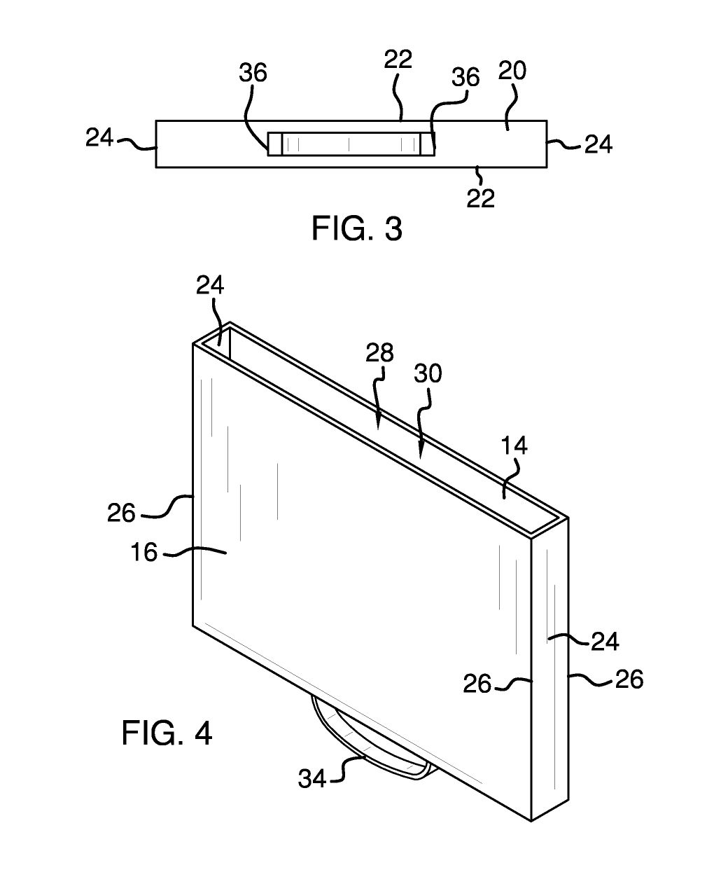

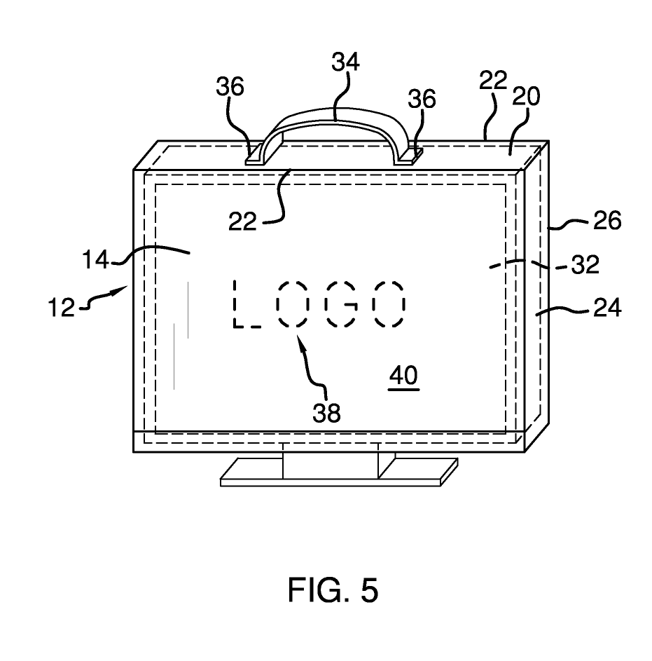

With reference now to the drawings, and in particular to FIGS. 1 through 5 thereof, a new cover device embodying the principles and concepts of an embodiment of the disclosure and generally designated by the reference numeral 10 will be described.

As best illustrated in FIGS. 1 through 5, the display screen dust cover device 10 generally comprises a cover 12 having a front panel 14, a back panel 16, and a perimeter wall 18 coupled to and extending between the front panel 14 and the back panel 16. The perimeter wall 18 has a top section 20 extending along respective top edges 22 of the front panel 12 and the back panel 14. The perimeter wall 18 has a pair of lateral sections 24 coupled to and extending between respective associated side edges 26 of the front panel 14 and the back panel 16 wherein the perimeter wall 18 defines an interior space 28 between the front panel 14 and the back panel 16. The cover 12 has an open bottom 30.

The front panel 14 and the back panel 16 are each rectangular and substantially planar wherein the interior space 28 is configured for receiving a video display monitor 32 wherein the cover 12 inhibits dust from accumulating on the video display monitor 32. Each of the lateral sections 24 of the perimeter wall 18 extends a full length of the respective associated side edges 26 of the front panel 14 and the back panel 16. The cover 12 is constructed of conventionally known anti-static fabric material to prevent damage to the video display monitor 32 due to accumulation of static electricity. The cover 12 may also be waterproof to protect the video display monitor 32 from damage related to liquid spills or the like.

A handle 34 is coupled to the cover 12. The handle 34 extends outwardly from the cover 12 facilitating lifting of the cover 12 to permit viewing of the video display monitor 32. The handle 34 may be flat having a substantially rectangular cross-sectional shape extending between opposed ends 36. Each of the opposed ends 36 is coupled to the top section 20 of the perimeter wall 18. Indicia 38, such as a business or sports logo, may be positioned on an outer face 40 of the front panel 14 of the cover 12.

In use, the cover 12 is placed over the video display monitor 32 by sliding the cover 12 over and onto the video display monitor 32 such that the video display monitor 32 is positioned in the interior space 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A display screen dust cover device comprising:
a cover having a front panel, a back panel, and a perimeter wall coupled to and extending between said front panel and said back panel, said perimeter wall having a top section extending along respective top edges of said front panel and said back panel, said perimeter wall having a pair of lateral sections coupled to and extending between respective associated side edges of said front panel and said back panel wherein said perimeter wall defines an interior space between said front panel and said back panel; and
a handle coupled to said cover, said handle extending outwardly from said cover facilitating lifting of said cover.

2. The device of claim 1, further comprising said front panel and said back panel each being rectangular and substantially planar wherein said interior space is configured for receiving a video display monitor wherein said cover inhibits dust from accumulating on the video display monitor.

3. The device of claim 1, further comprising said handle having opposed ends, each of said opposed ends being coupled to said top section of said perimeter wall.

4. The device of claim 1, further comprising each of said lateral sections of said perimeter wall extending a full length of said respective associated side edges of said front panel and said back panel.

5. The device of claim 1, said cover being constructed of an anti-static fabric material.

6. The device of claim 1, further comprising indicia positioned on an outer face of said front panel of said cover.

7. The device of claim 1, further comprising said cover being waterproof.

8. A display screen dust cover device comprising:
a cover having a front panel, a back panel, and a perimeter wall coupled to and extending between said front panel and said back panel, said perimeter wall having a top section extending along respective top edges of said front panel and said back panel, said perimeter wall having a pair of lateral sections coupled to and extending between respective associated side edges of said front panel and said back panel wherein said perimeter wall defines an interior space between said front panel and said back panel, said front panel and said back panel each being rectangular and substantially planar wherein said interior space is configured for receiving a video display monitor wherein said cover inhibits dust from accumulating on the video display monitor, each of said lateral sections of said perimeter wall extending a full length of said respective associated side edges of said front panel and said back panel, said cover being constructed of an anti-static fabric material, said cover being waterproof; and
a handle coupled to said cover, said handle extending outwardly from said cover facilitating lifting of said cover, said handle having opposed ends, each of said opposed ends being coupled to said top section of said perimeter wall; and
indicia positioned on an outer face of said front panel of said cover.
